(19) United States
(12) Patent Application Publication
(10) Pub. No.: US 2004/0156989 A1
(43) Pub. Date: Aug. 12, 2004

(54) Liquid crystal dropping apparatus and method

(75) Inventor: Shinichi Ogimoto, Ebina-Shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SHIBAURA MECHATRONICS CORPORATION, Yokohama-Shi (JP)

(21) Appl. No.: 10/649,700

(22) Filed: Aug. 28, 2003

(30) Foreign Application Priority Data
Aug. 29, 2002 (JP) 2002-251900

(51) Int. Cl. B05D 5/00

(52) U.S. Cl. 427/256; 118/300

(57) ABSTRACT

A liquid crystal dropping apparatus is capable of achieving a high-speed liquid crystal dropping operation and of improving the productivity. The liquid crystal dropping apparatus 10 includes a container 40 for containing a liquid crystal L, a liquid crystal dispensing device 20 for dropping the liquid crystal L contained in the container 40 on a substrate 1, and a stage-moving device 12 for moving the substrate 1 relative to the liquid crystal dispensing device 20. The liquid crystal dispensing device 20 includes a sucking means (suction port 21 and such) for taking out from the container 40 a quantity of the liquid crystal L corresponding to a quantity of the liquid crystal L to be dropped, a temporary storage means (storage chambers 22) for temporarily storing the liquid crystal L taken out from the container 40, and a discharge means (discharge port 23 and such) for discharging the temporarily stored liquid crystal L.

### BACKGROUND OF THE INVENTION

1. Field of the Invention

The present invention relates to a liquid crystal dropping apparatus and a liquid crystal dropping method for dropping a liquid crystal, i.e., a liquid substance. More particularly, the present invention relates to a liquid crystal dropping apparatus and a liquid crystal dropping method for dropping a plurality of liquid crystal drops in a predetermined pattern on a substrate.

2. Description of the Related Art

A liquid crystal must be sealed between two glass substrates in fabricating a liquid crystal display panel. In a recent method of sealing a liquid crystal between two substrates, a necessary quantity of a liquid crystal is dropped on one of the two substrates, and then the two substrates are bonded together with the liquid crystal being sandwiched between the two substrates.

A conventional liquid crystal dropping apparatus disclosed in JP2001-133799A, which is employed in carrying out such a method, includes: a liquid crystal container for storing a liquid crystal, i.e., a liquid substance; and a nozzle connected by a line to the liquid crystal container. The line is opened and closed by controlling a needle valve or a piston. The liquid crystal stored in the liquid crystal container is discharged through the nozzle by opening the needle valve or operating the piston to drop the liquid crystal onto a substrate.

The conventional liquid crystal dropping apparatus needs much time for dropping a single liquid crystal drop. Therefore, for the pursuit of improving the productivity, it is necessary to increase the number of liquid crystal dropping apparatuses by additionally installing a new liquid crystal dropping apparatus, which increases production cost.

### SUMMARY OF THE INVENTION

The present invention has been made in view of the foregoing problems, and it is therefore an object of the present invention to provide a liquid crystal dropping apparatus and a liquid crystal dropping method capable of achieving a high-speed liquid crystal dropping operation and of improving the productivity.

According to a first aspect of the present invention, a liquid crystal dropping apparatus for dropping a plurality of liquid crystal drops in a predetermined pattern on a substrate comprises: a container that contains a liquid crystal; a liquid crystal dispensing device that drops the liquid crystal contained in the container on the substrate; and a moving device that moves the liquid crystal dispensing device and the substrate relative to each other; wherein the liquid crystal dispensing device includes: a sucking means for taking out from the container a quantity of the liquid crystal corresponding to a quantity of the liquid crystal to be dropped; a temporary storage means for temporarily storing the liquid crystal taken out from the container by the sucking means; and a discharge means for discharging the liquid crystal temporarily stored by the temporary storage means.

In the liquid crystal dropping apparatus according to the first aspect of the present invention, it is preferable that the liquid crystal dispensing device includes a plurality of temporary storage means; and the liquid crystal dropping apparatus further comprises a locating means that locates the sucking means and the discharge means relative to the plurality of temporary storage means such that a liquid crystal sucking operation of the sucking means and a liquid crystal discharging operation of the discharge means are simultaneously performed.

In the liquid crystal dropping apparatus according to the first aspect of the present invention, it is preferable that the plurality of temporary storage means of the liquid crystal dispensing device include a plurality of storage chambers formed in a rotary member that rotates relative to a stationary member; the sucking means includes a suction port formed in the stationary member, and a sucking mechanism for taking out the liquid crystal through the suction port into each of the storage chambers of the rotary member; the discharge means includes a discharge port formed in the stationary member, and an extruding mechanism for extruding the liquid crystal from each of the storage chambers of the rotary member through the discharge port; and the locating means includes a drive mechanism for rotating the rotary member relative to the stationary member to locate each of the storage chambers of the rotary member at a position corresponding to the suction port of the stationary member and at a position corresponding to the discharge port of the stationary member.

In the liquid crystal dropping apparatus according to the first aspect of the present invention, it is preferable that the sucking mechanism of the sucking means and the extruding mechanism of the discharge means include plungers fitted for reciprocation in the storage chambers of the rotary member, and a plunger moving mechanism for reciprocating the plungers. Preferably, the plunger moving mechanism includes a cam or cylinder actuators for reciprocating the plungers in accordance with positions respectively corresponding to the suction port and the discharge port.

Preferably, the liquid crystal dropping apparatus according to the first aspect of the present invention further comprises: a position sensor that detects a positional relation between the liquid crystal dispensing device and the substrate; and a controller that controls timing of a liquid crystal discharging operation of the liquid crystal dispensing device on the basis of position information about the positional relation between the liquid crystal dispensing device and the substrate provided by the position sensor and on the basis of dropping position information about predetermined positions on the substrate where the liquid crystal is to be dropped.

Preferably, the liquid crystal dropping apparatus according to the first aspect of the present invention further comprises a controller that controls the moving device and the liquid crystal dispensing device on the basis of a relative moving speed between the liquid crystal dispensing device and the substrate and on the basis of a discharge time interval at which the liquid crystal is discharged by the liquid crystal dispensing device, the relative moving speed and the discharge time interval being determined beforehand on the basis of a drop position interval between positions where the liquid crystal is to be dropped on the substrate.

Preferably, the liquid crystal dropping apparatus according to the first aspect of the present invention further comprises a discharge adjusting device that adjusts the quantity of the liquid crystal to be discharged by the liquid crystal dispensing device.

According to a second aspect of the present invention, a liquid crystal dropping method of dropping a plurality of liquid crystal drops on a substrate in a predetermined pattern by moving a liquid crystal dispensing device, which drops a liquid crystal, and the substrate relative to each other, comprises: a sucking step of taking out a quantity of the liquid crystal, which is to be dropped, from a container storing the liquid crystal into the liquid crystal dispensing device; a temporarily storing step of temporarily storing the liquid crystal, which is taken out from the container in the sucking step, in the liquid crystal dispensing device; and a discharging step of discharging the liquid crystal, which is temporarily stored in the temporarily storing step, onto the substrate by the liquid crystal dispensing device.

In the liquid crystal dropping method according to the second aspect of the present invention, it is preferable that the liquid crystal dispensing device includes a plurality of temporary storage means for temporarily storing the liquid crystal taken out in the sucking step; and the liquid crystal taken out in the sucking step is sequentially stored in the plurality of temporary storage means to simultaneously perform the sucking step and the discharge step.

Preferably, the liquid crystal dropping method according to the second aspect of the present invention further comprises: a detecting step of detecting a positional relation between the liquid crystal dispensing device and the substrate; and a determining step of determining timing of a liquid crystal discharging operation of the liquid crystal dispensing device on the basis of position information about the positional relation detected in the detecting step and on the basis of drop position information about predetermined positions on the substrate where the liquid crystal is to be dropped.

Preferably, the liquid crystal dropping method according to the second aspect of the present invention further comprises a determining step of determining a relative moving speed between the liquid crystal dispensing device and the substrate, and a discharge time interval at which the liquid crystal is discharged by the liquid crystal dispensing device, on the basis of a drop position interval between positions where the liquid crystal is to be dropped on the substrate; wherein the liquid crystal dispensing device and the substrate are moved relative to each other at the relative moving speed determined in the determining step; and the liquid crystal is dropped by the liquid crystal dispensing device at the discharge time interval determined in the determining step.

Preferably, the liquid crystal dropping method according to the second aspect of the present invention further comprises a discharge adjusting step of adjusting the quantity of the liquid crystal to be discharged by the liquid crystal dispensing device.

According to the present invention, a quantity of the liquid crystal corresponding to a quantity of the liquid crystal to be dropped every liquid crystal dropping cycle is taken out and stored beforehand, and the necessary quantity of the liquid crystal can be dropped simply by discharging all the stored liquid crystal. Thus, the liquid crystal can quickly be dropped by a high-speed liquid crystal dropping operation, so that the productivity can further be improved.

According to the present invention, the liquid crystal can stably dropped on the substrate even while the liquid crystal dispensing device and the substrate are moved relative to each other because the liquid crystal can quickly be dropped, so that the productivity can further be improved.

According to the present invention, the timing of the liquid crystal discharging operation of the liquid crystal dispensing device is controlled on the basis of information about the positional relation between the liquid crystal dispensing device and the substrate and on the basis of information about the predetermined positions where the liquid crystal is to be dropped on the substrate. Therefore, the present invention is able to readily cope with changes in the number of liquid crystal drops to be dropped on the substrate and in positions where the liquid crystal is to be dropped, simply by changing the liquid crystal discharge timing on the basis of information about the changed drop positions where the liquid crystal is to be dropped. Thus, the liquid crystal drops can easily be dropped in an optimum pattern so that the liquid crystal can uniformly be spread when the two substrates are bonded together.

According to the present invention the moving device and the liquid crystal dispensing device are controlled on the basis of the relative moving speed between the liquid crystal dispensing device and the substrate and on the basis of the discharge time interval at which the liquid crystal is discharged by the liquid crystal dispensing device. The relative moving speed and the discharge time interval are determined on the basis of the drop position interval between positions where the liquid crystal is to be dropped on the substrate. Therefore, the present invention is able to readily cope with changes in the drop position interval between positions where the liquid crystal is to be dropped on the substrate, simply by changing the relative moving speed and the discharge time interval on the basis of the changed drop position interval between positions where the liquid crystal is to be dropped on the substrate. Thus, the liquid crystal drops can easily be dropped in an optimum pattern so that the liquid crystal can uniformly be spread when the two substrates are bonded together.

According to the present invention, the quantity of the liquid crystal, which forms a single liquid crystal drop to be dropped every liquid crystal dropping cycle, can be adjusted to a proper quantity by adjusting the quantity of the liquid crystal to be discharged by the adjusting device. Thus, liquid crystal drops can easily be dropped in an optimum pattern so that the liquid crystal can uniformly be spread when the two substrates are bonded together, while increasing the number of liquid crystal drops on the substrate.

### BRIEF DESCRIPTION OF THE DRAWINGS

FIG. 1A is a schematic sectional view of a liquid crystal dropping apparatus in a preferred embodiment of the present invention;

FIG. 1B is a schematic view of a substrate bonding apparatus for bonding together a substrate on which a liquid crystal has been dropped and another substrate;

FIG. 2A is a schematic sectional view of an essential part of the liquid crystal dispensing device included in the liquid crystal dropping apparatus shown in FIG. 1A;

FIG. 2B is a schematic sectional view of the liquid crystal dispensing device taken in the direction of the arrow A in FIG. 2A;

FIG. 2C is a schematic sectional view of a liquid crystal dispensing device in a modification of the liquid crystal dispensing deice shown in FIG. 2A;

FIG. 3 is a typical view of a pattern of liquid crystal drops dropped on a substrate by the liquid crystal dropping apparatus shown in FIG. 1A; and

FIG. 4 is a schematic sectional view of an essential part of a liquid crystal dispensing device in a modification of the liquid crystal dispensing device included in the liquid crystal dropping apparatus shown in FIG. 1A.

### DESCRIPTION OF THE PREFERRED EMBODIMENTS

Preferred embodiments of the present invention will be described with reference to the accompanying drawings.

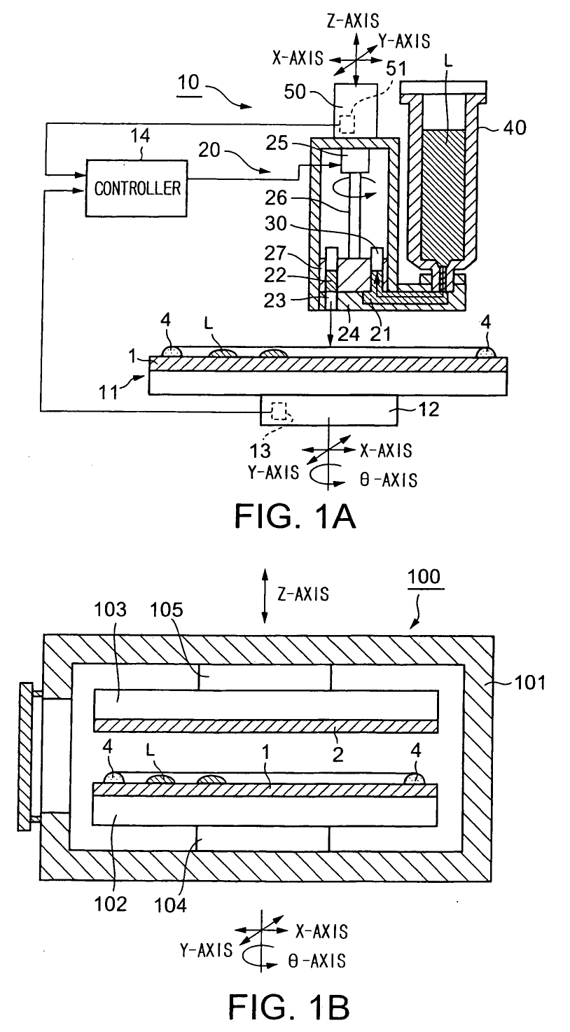

The general construction of a liquid crystal dropping apparatus in a preferred embodiment of the present invention will be described with reference to FIG. 1A. The liquid crystal dropping apparatus embodying the present invention drops a liquid crystal on one of a pair of substrates (upper and lower substrates) (for example, the lower substrate) to be bonded by a substrate bonding apparatus shown in FIG. 1B.

Referring to FIG. 1A, a liquid crystal dropping apparatus 10 in a preferred embodiment of the present invention drops a liquid crystal L, i.e., a liquid substance, in a pattern of a plurality of drops on a lower substrate 1. The liquid crystal dropping apparatus 10 includes a substrate carrying stage 11 for supporting the lower substrate 1 thereon, and a liquid crystal dispensing device 20 for dropping the liquid crystal L in drops of a predetermined quantity at a predetermined plurality of positions on the lower substrate 1.

The substrate carrying stage 11 is mounted on a stage-moving device 12 including an X-axis drive unit, a Y-axis drive unit and a θ-axis drive unit. The lower substrate 1 mounted on the substrate carrying stage 11 can be moved along an X-axis and a Y-axis, and can be turned about a θ-axis. Those drive units of the stage-moving device 12 may include servomotors.

A liquid crystal container 40 for containing the liquid crystal L to be dropped on the lower substrate 1 by the liquid crystal dispensing device 20, and a dispenser-moving device 50 for moving the liquid crystal dispensing device 20 are combined with the liquid crystal dispensing device 20. The dispenser-moving device 50 includes an X-axis drive unit, a Y-axis drive unit and a Z-axis drive unit to move the liquid crystal dispensing device 20 along an X-axis, a Y-axis and a Z-axis. Those drive units of the dispenser-moving device 50 may include servomotors.

At least either the stage-moving device 12 or the dispenser-moving device 50 serves as a moving device for moving the liquid crystal dispensing device 20 relative to the lower substrate 1 mounted on the substrate carrying stage 11.

The liquid crystal dispensing device 20 includes a sucking means for taking out from the liquid crystal container 40 a quantity of the liquid crystal L equal to the quantity of a liquid crystal drop to be dropped, a temporary storage means for temporarily storing the liquid crystal L taken out by the sucking means, and a discharge means for discharging the liquid crystal L stored by the temporary storage means.

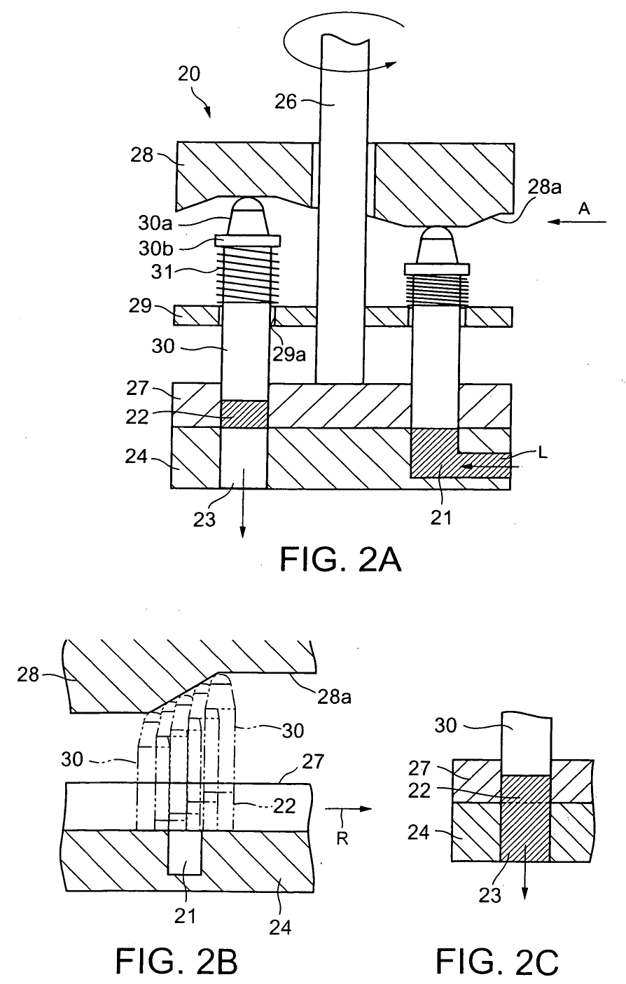

More concretely, as shown in FIGS. 1A and 2A, the liquid crystal dispensing device 20 includes a stationary member 24, and a rotary member 27 joined to a shaft 26 driven for rotation by a servomotor 25 and rotatable together with the shaft 26 relative to the stationary member 24. The stationary member 24 is provided with a suction port 21 and a discharge port 23. The suction port 21 and the discharge port 23 are disposed diametrically opposite to each other on a circle having its center on the axis of the shaft 26. The rotary member 27 is provided with two storage chambers 22 located such that one of the storage chambers 22 coincides with the suction port 21 when the other coincides with the discharge port 23. The rotary member 27 is in liquid-tight sliding contact with the stationary member 24. Each of the two storage chambers 22 alternately passes the suction port 21 and the discharge port 23 as the rotary member 27 rotates.

The liquid crystal dispensing device 20 includes a cam 28 disposed opposite to the rotary member 27. The cam 28 is held fixedly and coaxially with the shaft 26. Plungers 30 are fitted in the storage chambers 22 of the rotary member 27 and respectively extend between the cam 28 and the rotary member 27.

Each plunger 30 held for vertical movement in a guide hole 29a formed in a rotary plate 29 fixed to the shaft 26. A lower end part of each plunger 30 is fitted in the corresponding storage chamber 22 so as to move in opposite directions in the storage chamber 22. An upper end part (a cam follower 30a) of each plunger 30 is kept in contact with the cam surface 28a of the cam 28 as a plunger moving mechanism. Thus, the plunger 30 is reciprocated according to the shape of the cam surface 28a. A spring 31 is extended between the rotary plate 29, and a flange 30b formed in a middle part of the plunger 30.

The relation between the reciprocating mode of the plunger 30 and the shape of the cam surface 28a of the cam 28 will be described with reference to FIG. 2B.

Referring to FIG. 2B, the reciprocating mode of the plunger 30 is dependent on the shape of the cam surface 28a of the cam 28. Suppose that the storage chamber 22 of the rotary member 27 is passing across the suction port 21 of the stationary member 24. The storage chamber 22 moves in the direction of the arrow R shown in FIG. 2B. Preferably, the cam surface 28a of the cam 28 is designed such that the plunger 30 starts moving up when the leading end of the storage chamber 22 moves across the left edge of the suction port 21, and the plunger reaches its upper limit position and stops moving up when the trailing end of the storage chamber 22 moves across the right edge of the suction port 21. The upper limit position of the plunger 30 is determined taking into consideration the volume of the liquid crystal L that can be stored in the storage chamber 22. The upper limit position is determined so that the volume of the storage chamber 22 with the plunger 30 being at the upper limit position is equal to a quantity of the liquid crystal L to be dropped every liquid crystal dropping cycle.

Preferably, the cam surface 28a of the cam 28 is designed such that the plunger 30 is moved, when the storage chamber 22 of the rotary member 27 moves across the discharge port 23, in a moving mode reverse that in which the plunger 30 is moved when the storage chamber 22 passes across the suction port 21; that is, the plunger 30 starts moving down when the leading end of the storage chamber 22 of the rotary member 27 moves across the back edge, with respect to the moving direction of the storage chamber 22, of the discharge port 23, and the plunger 30 reaches its lower limit position and stops moving down when the trailing end of the storage chamber 22 moves across the front edge, with respect to the moving direction of the storage chamber 22, of the discharge port 23. Thus, all the liquid crystal L stored in the storage chamber 22 is discharged through the discharge port 23 onto the substrate 1.

In a state shown in FIG. 2A, the plunger 30 fitted in the storage chamber 22 of the rotary member 27 aligned with the suction port 21 is at the lower limit position, and the plunger 30 fitted in the other storage chamber 22 aligned with the discharge port 23 is at the upper limit position. However, the state shown in FIG. 2A is only for convenience' sake. Actually, the plunger 30 fitted in the storage chamber 22 is at a position between the upper and the lower limit positions when the storage chamber 22 is aligned with the suction port 21 or the discharge port 23, i.e., when the storage chamber 22 coincides completely with the suction port 21 or the discharge port 23, as shown in FIG. 2B.

FIG. 2A shows a state immediately before the discharge of the liquid crystal L stored in the storage chamber 22 through the discharge port 23, in which the liquid crystal L is contained only in the storage chamber 22 and any liquid crystal L is not contained in the discharge port 23. The state as shown in FIG. 2A is obtained when the plunger 30 is moved down at a high speed and all the liquid crystal L can be discharged by a single down stroke of the plunger 30 through the discharge port 23 without leaving any part of it in the discharge port 23. Although dependent on the thickness of the stationary member 24, it is possible that all the liquid crystal L stored in the storage chamber 22 cannot be discharged by a single down stroke of the plunger 30, a part or all the liquid crystal L remains in the discharge port 23, and unequal quantities of the liquid crystal L are discharged in different liquid crystal dropping cycles when the plunger 30 is moved down at a low speed. Therefore, when the plunger 30 is moved down at a low speed, the discharge port 23 may be filled up with the liquid crystal as shown in FIG. 2C by moving down the plunger 30 several times at a preparatory discharge stage. In actually discharging the liquid crystal, the liquid crystal contained in the storage chamber 22 is pushed into the discharge port 23 by the single down stroke of the plunger 30, and a quantity of the liquid crystal corresponding to that of the liquid crystal pushed into the discharge port 23 is discharged through the discharge port 23.

The servomotor 25 rotates the shaft 26 holding the rotary member 27 for a pumping operation that will be mentioned in paragraphs (A) and (B).

(A) Sucking Operation

The plunger 30 moves in the storage chamber 22 from the lower limit position to the upper limit position as the storage chamber 22 of the rotary member 27 moves across the suction port 21 as shown in FIG. 2B to suck the liquid crystal L contained in the liquid crystal container 40 through the suction port 21 into the storage chamber 22.

(B) Discharging Operation

The plunger 30 moves in the storage chamber 22 from the upper limit position to the lower limit position as the storage chamber 22 of the rotary member 27 moves across the discharge port 23 to discharge the liquid crystal L temporarily stored in the storage chamber 22 through the discharge port 23 in a single drop of liquid crystal onto the substrate 1.

Since the rotary member 27 is provided with the two storage chambers 22, the storage chambers 22 can simultaneously be located at positions corresponding to the suction port 21 and the discharge port 23 of the stationary member 24, respectively, by rotating the rotary member 27 relative to the stationary member 24. Thus, the sucking operation mentioned in (A) for sucking the liquid crystal L through the suction port 21 into the storage chamber 22, and the discharging operation mentioned in (B) for discharging the liquid crystal L from the storage chamber 22 through the discharge port 23 can simultaneously be performed.

As apparent from the foregoing description, in this preferred embodiment, the storage chambers 22 of the rotary member 27 form a storage means. The suction port 21 of the stationary member 24, and a suction mechanism for sucking the liquid crystal L through the suction port 21 into the storage chambers 22, including the plungers 30 and the cam 28, form a suction means. The discharge port 23 of the stationary member 24 and a extruding mechanism including the plungers 30 and the cam 28 for extruding the liquid crystal L from the storage chambers 22 of the rotary member 27, form a discharge means. A drive mechanism including the servomotor 25 form a locating means.

Referring again to FIG. 1A, the liquid crystal dropping apparatus 10 is provided with position sensors 13 and 51 for detecting the positional relation between the liquid crystal dispensing device 20 and the lower substrate 1 mounted on the substrate carrying state 11. In addition, the liquid crystal dropping apparatus 10 is also provided with a liquid crystal discharge controller 14 for actuating the liquid crystal dispensing device 20 and controlling the stage-moving device 12 on the basis of position information provided by the position sensors 13 and 51, i.e., information about the positional relation between the liquid crystal dispensing device 20 and the lower substrate 1.

The position sensor 13 is an encoder combined with the servomotors included in the drive units of the stage-moving device 12, and the position sensor 51 is an encoder combined with the servomotors included in the drive units of the dispenser-moving device 50. The output signals provided by those encoders give position information about the position of the substrate carrying stage 11 and position information about the position of the liquid crystal dispensing device 20. The positional relation between the discharge port 23 of the liquid crystal dispensing device 20 and the lower substrate 1 mounted on the substrate carrying stage 11 is obtained on the basis of the aforementioned position information.

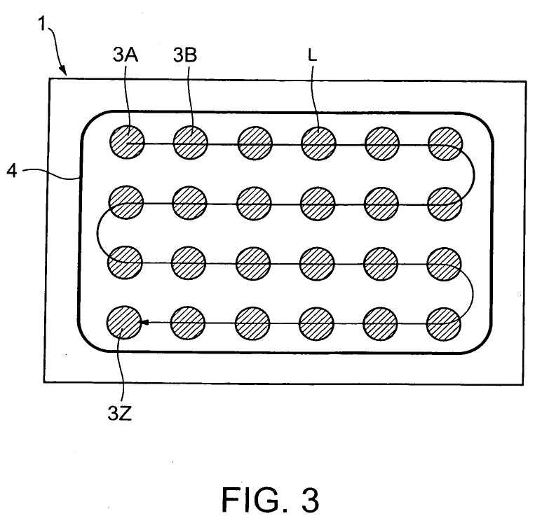

Suppose that drops of the liquid crystal L are dropped on the lower substrate 1 in a pattern shown in FIG. 3, a pattern of drops in lines and rows parallel to the sides of the lower substrate 1 at equal longitudinal and transverse intervals, the discharge port 23 of the liquid crystal dispensing device 20 moves along, for example, a meandering port-moving path (dropping path) shown in FIG. 3 formed by connecting straight paths at their right and the left ends by U-shaped turns. In FIG. 3, indicated at 3A, 3B, . . . and 3Z are drop positions, and at 4 is a sealing frame. The drop position 3A is a drop starting position, and the drop position 3Z is a drop ending position.

The controller 14 makes the liquid crystal dispensing device 20 discharge the liquid crystal L through the discharge port 23 thereof onto the lower substrate 1 at the drop positions excluding the drop positions at the opposite ends of the straight paths on the basis of the position information provided by the position sensors 13 and 51 (the positional relation between the liquid crystal dispensing device 20 and the lower substrate 1) without stopping the relative movement between the liquid crystal dispensing device 20 and the lower substrate 1. The controller 14 stops the relative movement between the liquid crystal dispensing device 20 and the lower substrate 1 at the drop positions at the opposite ends of the straight paths on the basis of the position information provided by the position sensors 13 and 51 (the positional relation between the liquid crystal dispensing device 20 and the lower substrate 1) and makes the liquid crystal dispensing device 20 discharge the liquid crystal L through the discharge port 23 thereof onto the lower substrate 1 at the drop positions at the opposite ends of the straight paths.

The controller 14 determines the position information about the position of the substrate carrying stage 11 on the basis of the output signals provided by the encoder (the position sensor 13) combined with the servomotors of the drive units of the stage-moving device 12, and determines position information about the position of the discharge port 23 of the liquid crystal dispensing device 20 with respect to directions along the X-axis and the Y-axis on the basis of the output signals provided by the encoder (the position sensor 51) combined with the servomotors of the X-axis drive unit and the Y-axis drive unit of the dispenser-moving device 50.

The controller 14 controls the timing of the discharging operation of the liquid crystal dispensing device 20 for discharging the liquid crystal L onto the lower substrate 1 on the basis of the measured position information about the positional relation between the liquid crystal dispensing device 20 and the lower substrate 1, and previously determined or previously taught dripping position information specifying positions at which the liquid crystal L is to be discharged onto the lower substrate 1. More concretely, the controller 14 gives a liquid crystal discharge command signal to the liquid crystal dispensing device 20 at times when the discharge port 23 of the liquid crystal dispensing device 20 passes the predetermined drop positions 3A, 3B, . . . and 3Z on the lower substrate 1.

The liquid crystal dispensing device 20 operates under the control of the controller 14, the servomotor 25 controls the number of liquid crystal dropping cycles and controls the timing of a liquid crystal discharging operation, and all the liquid crystal L stored in the storage chamber 22 by the sucking operation is discharged every cycle of the discharging operation through the discharge port 23. Since the volume of the storage chamber at this stage is equal to the quantity of the liquid crystal L to be dropped in one cycle of the discharging operation, a necessary quantity of the liquid crystal L can be dropped when all the liquid crystal L stored in the storage chamber 22 is discharged. Thus, the discharge of the liquid crystal L does not need to be regulated and hence the liquid crystal L can stably and quickly be dropped. Since the necessary quantity of the liquid crystal L can be discharged at each of the drop positions 3A, 3B . . . and 3Z without stopping the substrate carrying stage 11, a dropping process can be completed in a remarkably reduced time.

After a predetermined number of drops of the liquid crystal L have been dropped on the lower substrate 1 by the liquid crystal dropping apparatus 10, a substrate bonding apparatus 100 shown in FIG. 1B bonds together the lower substrate 1 and an upper substrate 2 with the sealing frame 4 held between the lower substrate 1 and the upper substrate 2.

The substrate bonding apparatus 100 will be described with reference to FIG. 1B.

Referring to FIG. 1B, the substrate bonding apparatus 100 has a vacuum vessel 101, a lower stage 102 placed in the vacuum vessel 101, and an upper stage 103 placed in the vacuum vessel 101.

A lower moving device 104 is connected to the lower stage 102, and an upper moving device 105 is connected to the upper stage 103. The lower moving device 104 includes an X-axis drive unit, a Y-axis drive unit and a θ-axis drive unit to move the lower substrate 1 held on the lower stage 102 in directions along an X-axis and a Y-axis and to turn the same about a θ-axis. The upper moving device 105 includes a Z-axis drive unit to move the upper substrate 2 held on the upper stage 103 in directions along a Z-axis. The lower substrate 1 held on the lower stage 102 (the one being provided with the plurality of drops of the liquid crystal L dropped in a pattern by the liquid crystal dispensing device 20) and the upper substrate 2 held on the upper stage 103 are bonded together in the vacuum vessel 101.

The operation of the liquid crystal dropping apparatus 10 will be described in connection with that of the substrate bonding apparatus 100.

Step (1): The dispenser-moving device 50 of the liquid crystal dropping apparatus 10 moves the liquid crystal dispensing device 20 to locate the discharge port 23 at the drop starting position.

Step (2): Subsequently, the lower substrate 1 provided with the sealing frame 4 formed by applying a sealing material in a loop as shown in FIG. 3 is mounted on the substrate carrying stage 11. The deviation of the lower substrate 1 from a correct position on the substrate carrying stage 11 is measured by using positioning marks formed on the lower substrate 1.

Step (3): Then, the stage-moving device 12 moves the substrate carrying stage 11 to adjust the position of the lower substrate 1 with reference to the deviation measured by the step (2) so that the first drop position 3A (FIG. 3) is located directly below the discharge port 23 of the liquid crystal dispensing device 20 positioned at the drop starting position by the step (1).

Step (4): Then, the substrate carrying stage 11 is moved by the stage-moving device 12 to move the lower substrate 1 held on the substrate carrying stage 11 relative to the discharge port 23 of the liquid crystal dispensing device 20 such that the discharge port 23 moves along the port-moving path relative to the lower substrate 1, and the liquid crystal dispensing device 20 discharges the liquid crystal L in drops through the discharge port 23 at the drop positions 3A, 3B, . . . and 3Z. Meanwhile, the controller 14 detects the drop positions at which the liquid crystal L must be dropped on the lower substrate on the basis of the output signals provided by the encoders (the position sensors 13 and 51) combined with the servomotors included in the drive units of the moving devices 12 and 50, and drives the liquid crystal dispensing device 20 to discharge the liquid crystal L onto the lower substrate 1 when the drop positions 3A, 3B, . . . and 3Z pass under the discharge port 23 of the liquid crystal dispensing device 20.

Step (5): Then, the upper substrate 2 is delivered to the upper stage 103 of the substrate bonding apparatus 100.

Step (6): The lower substrate 1 that carries the drops of the liquid crystal L formed in the step (4) is delivered to the lower stage 102 of the substrate bonding apparatus 100.

Step (7): The vacuum vessel 101 of the substrate bonding apparatus 100 is evacuated to a vacuum, the lower moving device 104 and the upper moving device 105 move the lower stage 102 and the upper stage 103, respectively, to align the lower substrate 1 and the upper substrate 2 and to bond together the lower substrate 1 and the upper substrate 2 with the sealing frame 4 held between the lower substrate 1 and the upper substrate 2 in a vacuum atmosphere. Then, the vacuum vessel 101 is opened to the atmosphere, and the assembly of the lower substrate 1 and the upper substrate 2 is irradiated with UV light by a UV irradiation apparatus to cure the sealing frame 4 temporarily. Preferably, the UV irradiation apparatus is provided with a substrate carrying stage, not shown, to carry a liquid crystal cell formed by bonding together the lower substrate 1 and the upper substrate 2 out of the vacuum vessel 101.

Step (8): Finally, the liquid crystal cell formed by bonding together the lower substrate 1 and the upper substrate 2 by the substrate bonding apparatus 100 is carried away from the substrate bonding apparatus 100.

The steps (2) and (3) may be executed before the step (1). When the liquid crystal dispensing device 20 is moved in the step (1) before feeding the lower substrate 1 in the steps (2) and (3), it is possible to prevent the contamination of the lower substrate 1 with dust produced by the operations of the drive units of the dispenser-moving device 50 for moving the liquid crystal dispensing device 20. If the drive units are provided with dust-preventive means, the step (1) to move the liquid crystal dispensing device 20 may be executed after the lower substrate 1 has been mounted on the substrate carrying stage 11 and located in the steps (2) and (3).

In the step (2), the lower substrate 1 provided with the sealing frame 4 having the shape of a closed loop (FIG. 3) is mounted on the substrate carrying stage 11. The lower substrate 1 not provided with the sealing frame 4 may be mounted on the substrate carrying stage 11, the lower substrate 1 that carries the drops of the liquid crystal L, and the upper substrate 2 provided with the sealing frame 4 having the shape of a closed loop may be bonded together in the steps (5) to (7) after completing the steps (3) and (4).

Although the steps (1) to (4) have been described on an assumption that the liquid crystal dropping apparatus 10 provided with the single liquid crystal dispensing device 20 is used for dropping the liquid crystal L on the lower substrate 1, a liquid crystal dropping apparatus 10 provided with a plurality of liquid crystal dispensing devices 20 may be used, and the plurality of liquid crystal dispensing devices 20 may selectively be used depending on drop positions or may simultaneously be used.

In such a case, it is preferable that the storage chambers 22 of the plurality of liquid crystal dispensing devices 20 are formed in different volumes, respectively, to make the plurality of liquid crystal dispensing devices 20 discharge different quantities of the liquid crystal L every liquid crystal dropping cycle. Thus, it is possible to realize easily dividing a part, surrounded by the sealing frame 4 as shown in FIG. 3, of the surface of the lower substrate 1, into a plurality of regions, and dropping drops of different quantities of the liquid crystal L at liquid crystal drop positions in different regions, respectively. More concretely, it is possible to drop a plurality of drops of a small quantity of the liquid crystal L at liquid crystal drop positions in the peripheral regions contiguous with the sealing frame 4, and to drop a plurality of drops of a large quantity of the liquid crystal L at liquid crystal drop positions in the central regions. It is possible to effectively prevent the liquid crystal L being squeezed out over the sealing frame 4 that is liable to occur when the lower substrate 1 and the upper substrate 2 are bonded together by dropping the drops of a small quantity of the liquid crystal L in the peripheral regions contiguous with the sealing frame 4.

When the liquid crystal dropping apparatus 10 is provided with the plurality of liquid crystal dispensing devices 20, it is preferable that the liquid crystal dispensing device 20 can individually be moved in directions along the X-axis and the Y-axis, which facilitates adjusting intervals between drops of the liquid crystal L dropped by the liquid crystal dispensing devices 20.

Although, in the steps (1) to (7), the liquid crystal L is dropped only on the lower substrate 1, and then the lower substrate 1 and the upper substrate 2 are bonded together, the liquid crystal L may be dropped on both the lower substrate 1 and the upper substrate 2, and then the lower substrate 1 and the upper substrate 2 may be bonded together.

In this embodiment, the quantity of the liquid crystal L to be dropped every liquid crystal dropping cycle is sucked into and stored in the storage chamber 22 of the liquid crystal dispensing device 20, and the necessary quantity of the liquid crystal L can be dropped simply by discharging all the liquid crystal L stored in the storage chamber 22. Consequently, the liquid L can quickly be dropped by a high-speed liquid crystal dropping operation, and thereby the productivity can be improved.

Since the liquid crystal L can quickly be dropped in this embodiment as mentioned above, the relative movement between the liquid crystal dispensing device 20 and the lower substrate 1 does not need to be stopped every time the liquid crystal L is dropped, and the liquid crystal L can stably be dropped onto the lower substrate 1 while the liquid crystal dispensing device 20 and the lower substrate 1 are moved relative to each other, and thereby the productivity can be improved.

Since the necessary quantity of the liquid crystal L is dropped by previously storing the quantity of the liquid crystal L for one liquid crystal dropping cycle in the storage chamber 22 and discharging all the liquid crystal L stored in the storage chamber 22, the quantity of the liquid crystal L to be dropped can easily be controlled, the irregular spread of the liquid crystal L due to forming drops of liquid crystal of different quantities can be prevented. Thus, a proper quantity of the liquid crystal L can be sealed in a space between the lower substrate 1 and the upper substrate 2 by the steps of bonding together the lower substrate 1 and the upper substrate 2, which improves the quality of the liquid crystal cell formed by bonding together the lower substrate 1 and the upper substrate 2.

Since the two storage chambers 22 are used in this embodiment to simultaneously perform the liquid crystal sucking operation and the liquid crystal discharging operation, the speed of the liquid crystal dropping operation can be increased, and thereby the productivity can be improved.

Since the timing of the liquid crystal discharging operation of the liquid crystal dispensing device 20 is controlled in this embodiment the basis of information about the positional relation between the liquid crystal dispensing device 20 and the lower substrate 1 and on the basis of information about the predetermined positions where the liquid crystal is to be dropped on the substrate, this embodiment is able to readily cope with changes in the number of drops of the liquid crystal L to be dropped on the lower substrate 1 and in positions where the liquid crystal L is to be dropped, simply by changing, under the control of the controller 14, the liquid crystal discharge timing on the basis of information about the changed drop positions where the liquid crystal L is to be dropped. Thus, the drops of the liquid crystal L can easily be dropped in an optimum pattern so that the liquid crystal L can uniformly be spread when the lower substrate 1 and the upper substrate 2 are bonded together.

Since the rotary member 27 provided with the storage chambers 22 rotates, the storage chambers 22 can smoothly be moved successively across the suction port 21 and the discharge port 23 at a high speed substantially without generating vibrations, and thereby the liquid crystal dropping operation for dropping the liquid crystal L can stably and quickly be carried out.

Since all the liquid crystal L sucked into and stored in the storage chamber 22 is discharged, the quantity of the liquid crystal L corresponding to the volume of the storage chamber 22 can surely be dropped irrespective of viscosty variation of the liquid crystal L.

Although, in this embodiment, the timing of the liquid crystal discharging operation of the liquid crystal dispensing device 20 is controlled on the basis of information about the positional relation between the liquid crystal dispensing device 20 and the lower substrate 1 and on the basis of information about the predetermined positions where the liquid crystal L is to be dropped on the lower substrate 1, and the liquid crystal L is discharged on the lower substrate 1 in the thus timed liquid crystal discharging operation by the liquid crystal dispensing device 20, the liquid crystal L may be discharged on the lower substrate 1 by a different method. For example, the relative moving speed between the liquid crystal dispensing device 20 and the lower substrate 1, and the discharge time interval at which the liquid crystal L is discharged by the liquid crystal dispensing device 20 may be determined on the basis of the arrangement of the drop positions, namely, the drop position interval between positions where the liquid crystal L is to be dropped, and the liquid crystal L may be discharged on the lower substrate 1 at the thus determined discharge time interval by moving the liquid crystal dispensing device 20 and the lower substrate 1 relative to each other at the thus determined relative moving speed.

More concretely, if the relative moving speed between the liquid crystal dispensing device 20 and the lower substrate 1 is fixed, the discharge time interval at which the liquid crystal L is to be discharged is increased when it is desired to increase the drop position interval between the positions where the liquid crystal L is to be dropped, or the discharge time interval at which the liquid crystal L is to be discharged is decreased when it is desired to decrease the drop position interval between the positions where the liquid crystal L is to be dropped. If the discharge time interval at which the liquid crystal L is to be discharged is fixed, the relative moving speed between the liquid crystal dispensing device 20 and the lower substrate 1 is increased when it is desired to increase the drop position interval between the positions where the liquid crystal L is to be dropped, or the relative moving speed between the liquid crystal dispensing device 20 and the lower substrate 1 is decreased when it is desired to decrease the drop position interval between the positions where the liquid crystal L is to be dropped. Naturally, the liquid crystal L may be dropped at drop positions spaced at a desired drop position interval by adjusting both the relative moving speed between the liquid crystal dispensing device 20 and the lower substrate 1, and the discharge time interval at which the liquid crystal L is to be discharged. The relation between the drop position interval, the relative moving speed between the liquid crystal dispensing device 20 and the lower substrate 1, and the discharge time interval can readily be determined by using an expression: (Drop position interval)=(Relative moving speed between the liquid crystal dispensing device 20 and the lower substrate 1)×(Discharge time interval).

When the positional relation between the liquid crystal dispensing device 20 and the lower substrate 1 is determined at the start of the liquid crystal dropping operation, the liquid crystal L can be dropped on the lower substrate 1 at the desired drop position interval simply by controlling the stage-moving device 12 and the liquid crystal dispensing device 20 of the liquid crystal dropping apparatus 10 on the basis of the set relative moving speed and the discharge time interval without measuring the positional relation between the liquid crystal dispensing device 20 and the lower substrate 1. Consequently, the drops of the liquid crystal L can easily be formed in an optimum pattern so that the liquid crystal L can uniformly be spread when the lower substrate 1 and the upper substrate 2 are bonded together.

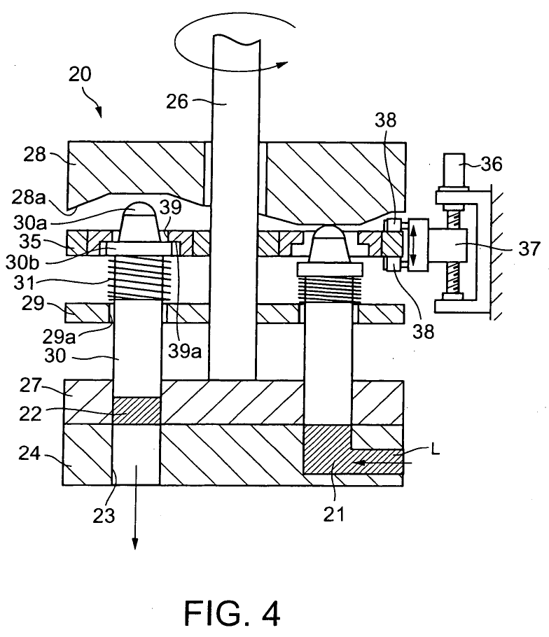

Although the quantity of the liquid crystal L to be discharged is determined by the volume of the storage chamber 22 in this embodiment, the liquid crystal dropping apparatus 10 may further be provided with an upstroke limiting member 35 for adjusting the upper limit position of the plunger 30 as shown in FIG. 4.

A liquid crystal dispensing device 20 shown in FIG. 4 is provided with the upstroke limiting member 35 that adjusts the upper limit position of the plunger 30 to adjust the quantity of the liquid crystal L to be discharged in one liquid crystal dropping cycle. The upstroke limiting member 35 is held between rollers 38 held one on top of the other on a vertically movable block 37. The vertically movable block 37 is engaged with an adjusting screw driven for rotation by a servomotor 36 controlled by a controller. The upstroke limiting member 35 is retained at a desired vertical position on the shaft 26 and rotates together with the rotary member 27 as the shaft 26 rotates. The upstroke limiting member 35 is provided with holes 39 through which the cam followers 30a of the plungers 30 pass. A step 39a that engages with the flange 30b of the plunger 30 is formed in each hole 39. The upward movement of the plunger 30 is limited by the engagement of the flange 30b with the step 39a to determine the upper limit position of the plunger 30. Consequently, the quantity of the liquid crystal L that can be sucked into the storage chamber 22 can be changed to change the quantity of the liquid crystal L to be discharged from the storage chamber 22.

The quantity of the liquid crystal L to be dropped every liquid crystal dropping cycle can promptly be adjusted to a proper value by changing the quantity (volume) of the liquid crystal L that can be sucked into the storage chamber 22 through the adjustment of the vertical position of the upstroke limiting member 35. Thus, drops of the liquid crystal L can readily be arranged in an optimum pattern so that the liquid crystal L can uniformly be spread when the lower substrate 1 and the upper substrate 2 are bonded together, while increasing the number of drops of the liquid crystal L on the lower substrate 1. Moreover, the prompt adjustment of the quantity of the liquid crystal L to be dropped every liquid crystal dropping cycle makes it possible to divide a part, surrounded by the sealing frame 4 as shown in FIG. 3, of the surface of the lower substrate 1, into a plurality of regions, and drop drops of different quantities of the liquid crystal L in different regions, respectively, and the degree of freedom of designing a liquid crystal drop pattern can further be increased.

In FIG. 4, the quantity of the liquid crystal L that can be sucked into the storage chamber 22 is adjusted by adjusting the upper limit position of the plunger 30 through the adjustment of the vertical position of the upstroke limiting member 35. The upstroke limiting member 35 may be held at a fixed vertical position and the vertical position of the cam 28 may be moved to a proper vertical position. Thus, the lower limit position of the plunger 30 can be adjusted to change the quantity of the liquid crystal L to be discharged from the storage chamber 22.

When the cam 28 and the upstroke limiting member 35 are thus arranged, a fixed quantity of the liquid crystal L dependent on the vertical position of the upstroke limiting member 35 is sucked into the storage chamber 22 regardless of the quantity of the liquid crystal L to be discharged, and a quantity of the liquid crystal L to be discharged by the liquid crystal discharge operation is dependent on the distance of the downstroke of the plunger 30 between the upper limit position determined by the upstroke limiting member 35 and a lower limit position dependent on the vertical position of the cam 28. The quantity of the liquid crystal L to be discharged every liquid crystal dropping cycle can be changed by such an arrangement of the cam 28 and the upstroke limiting member 35. Consequently, drops of the liquid crystal L can easily be formed in an optimum pattern so that the liquid crystal L can uniformly be spread when the lower substrate 1 and the upper substrate 2 are bonded together. In this case, it is preferable that a quantity of the liquid crystal L that can be stored in the storage chamber 22 is equal to the maximum quantity of the liquid crystal L to be discharged.

Although the preferred embodiments of the present invention have been described with reference to the accompanying drawings, the present invention is not limited thereto in its practical application, and any changes may be made in the design without departing from the scope of the present invention.

For example, the relative movement between the liquid crystal dispensing device 20 and the lower substrate 1 do not necessarily need to be achieved by the stage-moving device 12 that moves the substrate carrying stage 11, the same may be achieved by the dispenser-moving device 50 that moves the liquid crystal dispensing device 20 or by both the moving devices 12 and 50.

The liquid crystal dispensing device 20 does not need to be of a plunger pump type and may be of any other pump type.

The plungers 30 do not necessarily need to be reciprocated for an upstroke and a downstroke at positions respectively corresponding to the suction port 21 and the discharge port 23 of the stationary member 24 by the plunger moving mechanism including the cam 28; the plungers 30 may be reciprocated by cylinder actuators interlocked with the plunger 30, respectively.

The liquid crystal L does not necessarily need to be discharged in a single drop at each drop position; the liquid crystal L may be discharged in a plurality of drops at each drop position. Such a mode of discharging the liquid crystal L can be achieved by controlling the servomotor 25 such that the storage chamber 22 pass across the discharge port 23 a set number of times while the discharge port 23 of the liquid crystal dispensing device 20 pass each drop position on the lower substrate 1.

Both the stage-moving device 12 and the dispenser-moving device 50 do not need to be provided with the X-axis drive unit and the Y-axis drive unit. The liquid crystal dropping operation for dropping drops of the liquid crystal L on the lower substrate 1 can be carried out when at least either of the moving devices 12 and 50 is provided with the X-axis drive unit and the Y-axis drive unit.

The sensors 13 and 51 are not limited to the encoders combined with the servomotors of the drive units of the moving devices 12 and 50 and may be any suitable detectors.

The rotary member 27 may be provided with three or more storage chambers or only one storage chamber instead of the two storage chambers 22.

What is claimed is:

1. A liquid crystal dropping apparatus for dropping a plurality of liquid crystal drops in a predetermined pattern on a substrate, said liquid crystal dropping apparatus comprising:
a container that contains a liquid crystal;
a liquid crystal dispensing device that drops the liquid crystal contained in the container on the substrate; and
a moving device that moves the liquid crystal dispensing device and the substrate relative to each other;
wherein the liquid crystal dispensing device includes: a sucking means for taking out from the container a quantity of the liquid crystal corresponding to a quantity of the liquid crystal to be dropped; a temporary storage means for temporarily storing the liquid crystal taken out from the container by the sucking means.; and a discharge means for discharging the liquid crystal temporarily stored by the temporary storage means.

2. The liquid crystal dropping apparatus according to claim 1, wherein the liquid crystal dispensing device includes a plurality of temporary storage means; and the liquid crystal dropping apparatus further comprises a locating means that locates the sucking means and the discharge means relative to the plurality of temporary storage means such that a liquid crystal sucking operation of the sucking means and a liquid crystal discharging operation of the discharge means are simultaneously performed.

3. The liquid crystal dropping apparatus according to claim 2, wherein the plurality of temporary storage means of the liquid crystal dispensing device include a plurality of storage chambers formed in a rotary member that rotates relative to a stationary member; the sucking means includes a suction port formed in the stationary member, and a sucking mechanism for taking out the liquid crystal through the suction port into each of the storage chambers of the rotary member; the discharge means includes a discharge port formed in the stationary member, and an extruding mechanism for extruding the liquid crystal from each of the storage chambers of the rotary member through the discharge port; and the locating means includes a drive mechanism for rotating the rotary member relative to the stationary member to locate each of the storage chambers of the rotary member at a position corresponding to the suction port of the stationary member and at a position corresponding to the discharge port of the stationary member.

4. The liquid crystal dropping apparatus according to claim 3, wherein the sucking mechanism of the sucking means and the extruding mechanism of the discharge means include plungers fitted for reciprocation in the storage chambers of the rotary member, and a plunger moving mechanism for reciprocating the plungers.

5. The liquid crystal dropping apparatus according to claim 4, wherein the plunger moving mechanism includes a cam for reciprocating the plungers in accordance with positions respectively corresponding to the suction port and the discharge port.

6. The liquid crystal dropping apparatus according to claim 4, wherein the plunger moving mechanism includes a cylinder actuator for reciprocating the plunger in accordance with positions respectively corresponding to the suction port and the discharge port.

7. The liquid crystal dropping apparatus according to claim 1, further comprising:
a position sensor that detects a positional relation between the liquid crystal dispensing device and the substrate; and
a controller that controls timing of a liquid crystal discharging operation of the liquid crystal dispensing device on the basis of position information about the positional relation between the liquid crystal dispensing device and the substrate provided by the position sensor and on the basis of dropping position information about predetermined positions on the substrate where the liquid crystal is to be dropped.

8. The liquid crystal dropping apparatus according to claim 1, further comprising a controller that controls the moving device and the liquid crystal dispensing device on the basis of a relative moving speed between the liquid crystal dispensing device and the substrate and on the basis of a discharge time interval at which the liquid crystal is discharged by the liquid crystal dispensing device, the relative moving speed and the discharge time interval being determined beforehand on the basis of a drop position interval between positions where the liquid crystal is to be dropped on the substrate.

9. The liquid crystal dropping apparatus according to claim 1, further comprising a discharge adjusting device that adjusts the quantity of the liquid crystal to be discharged by the liquid crystal dispensing device.

10. A liquid crystal dropping method of dropping a plurality of liquid crystal drops on a substrate in a predetermined pattern by moving a liquid crystal dispensing device, which drops a liquid crystal, and the substrate relative to each other, said liquid crystal dropping method comprising:
a sucking step of taking out a quantity of the liquid crystal corresponding to a quantity of the liquid crystal to be dropped, from a container storing the liquid crystal into the liquid crystal dispensing device;
a temporarily storing step of temporarily storing the liquid crystal, which is taken out from the container in the sucking step, in the liquid crystal dispensing device; and
a discharging step of discharging the liquid crystal, which is temporarily stored in the temporarily storing step, onto the substrate by the liquid crystal dispensing device.

11. The liquid crystal dropping method according to claim 10, wherein the liquid crystal dispensing device includes a plurality of temporary storage means for temporarily storing the liquid crystal taken out in the sucking step; and the liquid crystal taken out in the sucking step is sequentially stored by the plurality of temporary storage means to simultaneously perform the sucking step and the discharge step.

12. The liquid crystal dropping method according to claim 10, further comprising:
a detecting step of detecting a positional relation between the liquid crystal dispensing device and the substrate; and
a determining step of determing timing of a liquid crystal discharging operation of the liquid crystal dispensing device on the basis of position information about the positional relation detected in the detecting step and on the basis of drop position information about predetermined positions on the substrate where the liquid crystal is to be dropped.

13. The liquid crystal dropping method according to claim 10, further comprising a determining step of determining a relative moving speed between the liquid crystal dispensing device and the substrate, and a discharge time interval at which the liquid crystal is discharged by the liquid crystal dispensing device, on the basis of a drop position interval between positions where the liquid crystal is to be dropped on the substrate;
wherein the liquid crystal dispensing device and the substrate are moved relative to each other at the relative moving speed determined in the determining step; and the liquid crystal is dropped by the liquid crystal dispensing device at the discharge time interval determined in the determining step.

14. The liquid crystal dropping method according to claim 10, further comprising a discharge adjusting step of adjusting the quantity of the liquid crystal to be discharged by the liquid crystal dispensing device.
